(19) United States
(12) Patent Application Publication
(10) Pub. No.: US 2024/0427053 A1
(43) Pub. Date: Dec. 26, 2024

(54) METHOD FOR IDENTIFYING LITHIUM-POTASSIUM-RICH BRINE RESERVOIRS BASED ON PARAMETER SENSITIVITY ANALYSIS

(71) Applicant: Chengdu University of Technology, Chengdu (CN)

(72) Inventors: Bing ZHANG, Chengdu (CN); Yuyong YANG, Chengdu (CN); Xiaoyang LIN, Chengdu (CN); Qian LI, Chengdu (CN); Zhengyang WANG, Chengdu (CN); Kai YANG, Chengdu (CN); Zhuo LI, Chengdu (CN); Xiaolong HE, Chengdu (CN)

(21) Appl. No.: 18/775,694

(22) Filed: Jul. 17, 2024

(30) Foreign Application Priority Data
Jul. 21, 2023 (CN) 202310899611.3

(51) Int. Cl. G01V 20/00; G01V 11/00

(52) U.S. Cl. CPC G01V 20/00; G01V 11/002

(57) ABSTRACT

A method for identifying high-quality lithium-potassium-rich brine reservoirs based on parameter sensitivity analysis is provided. Basic characteristics of a brine reservoir area are determined. The sensitive parameter analysis of the brine reservoir area is performed by rock physics modeling and cross-plotting of logging curves to determine a rock physics parameter range and a logging parameter range of the brine reservoir area. The relationship between the wave impedance and the water saturation based on the rock physics model. A coordinate range of a water-rich reservoir is determined based on the inversion result of the water saturation. Within the coordinate range of the water-rich reservoir, a coordinate range of the lithium-potassium-rich brine reservoir is determined based on the natural gamma inversion result obtained by waveform phase-controlled inversion, so as to achieve geophysical identification and prediction of high-quality brine reservoirs in the marine strata.

### CROSS-REFERENCE TO RELATED APPLICATIONS

This application claims the benefit of priority from Chinese Patent Application No. 202310899611.3, filed on Jul. 21, 2023. The content of the aforementioned application, including any intervening amendments made thereto, is incorporated herein by reference in its entirety.

### TECHNICAL FIELD

This application relates to the identification and prediction for high-quality lithium-potassium-rich brine reservoirs in marine strata, and more particularly to a method for identifying lithium-potassium-rich brine reservoirs based on parameter sensitivity analysis.

### BACKGROUND

Potassium is an essential element for plant growth and development, and plays a significant role in the grain production. Lithium, being the lightest metal, possesses the highest specific capacity and strong electron transfer ability, making it an ideal material for rechargeable batteries. Metallic lithium and its compounds, as critical resources and strategic materials for the development of high-tech industries, are non-renewable. Additionally, lithium has also been extensively applied in the controlled nuclear fusion, and thus it is widely recognized as the key metal for addressing the long-term energy issue. With the rapid development of new energy resources, potassium and lithium resources have gained significant attention, and the global demand for these resources has been increasingly growing. Compared to the current predominantly-developed solid lithium-potassium ores, brine-type lithium-potassium deposits are abundant, green and cost-effective. Brine-type lithium-potassium ores are mainly categorized into surface salt lake brine and underground brine. The underground brine has gained increasing attention due to its rich associated elements, low Mg/Li ratio, lower lithium extraction costs, and abundant Li resource reserves. However, as a deep-buried underground brine, the lithium-potassium-rich brine is often found at an underground depth of several kilometers, where the geological conditions are complex, and the brine reservoir is relatively thin, leading to low identification accuracy and high prediction difficulty. Therefore, an accurate and reliable method for identifying and predicting high-quality lithium-potassium-rich brine reservoirs is of great significance in the exploration and development of brine reservoirs.

In the current researches on deep lithium-potassium-rich brine, the sedimentary characteristics of reservoirs have not been classified according to marine and terrestrial sedimentary environments, and insufficient attention has been given to the water-bearing and brine-storage properties of the brine itself. Studies often focus solely on water-bearing characteristics, leading to overly simplistic identification markers, low inversion accuracy for thin reservoirs, and unsatisfied brine grade. As a result, the accurate identification and prediction of high-quality brine reservoirs cannot be achieved. Therefore, how to use relatively cost-effective geophysical data to effectively identify and accurately predict high-quality brine reservoirs has become a technical challenge urgent to be overcome.

### SUMMARY

To solve the above problems, a method for identifying high-quality lithium-potassium-rich brine reservoirs based on parameter sensitivity analysis is provided, comprising:
(S1) determining basic characteristics of a brine reservoir area to obtain a target geological formation based on geological data, hydrochemical analysis data, drilling and logging data and seismic data;
(S2) performing rock physics modeling based on a rock physics model of a porous medium, so as to establish a relationship between seismic parameters and reservoir parameters;
(S3) performing sensitive parameter analysis on a target section according to the drilling and logging data and the hydrochemical analysis data to determine an identification marker of the lithium-potassium-rich brine reservoir and a distribution range of the identification marker;
(S4) obtaining a relationship between a physical property parameter and an elastic parameter based on a rock physics model constructed in step (S2); and determining a coordinate range of a water-rich reservoir with a water content exceeding a preset value in the target geological formation according to water-bearing characteristic of the brine reservoir area based on an inversion result of a water saturation; and
(S5) within the coordinate range of the water-rich reservoir, obtaining an inversion result of a natural gamma by using waveform phase-controlled inversion; and based on the inversion result of the natural gamma, extracting a coordinate area within a distribution range of the natural gamma as a coordinate range of the lithium-potassium-rich brine reservoir.

In an embodiment, the basic characteristics of the lithium-potassium-rich brine reservoir area comprise a stratigraphic feature, a hydrochemical characteristic and a structural feature.

In an embodiment, the seismic parameter comprises a primary wave (P-wave) to shear wave (S-wave) velocity ratio and a P-wave impedance; and the reservoir parameter comprises porosity and water saturation.

In an embodiment, in step (S2), the rock physics model is identical to a target formation in composition and structure; and a P-wave velocity in the rock physics model is identical to a P-wave velocity in the target formation under different depths.

In an embodiment, in step (S3), the sensitive parameter analysis is performed on the target section by using cross-plot of logging curves.

In an embodiment, the logging curves comprise a natural gamma logging curve, an acoustic time difference logging curve and a resistivity logging curve

In an embodiment, step (S3) further comprises:
determining the distribution range of the lithium-potassium-rich brine reservoir by cross-plotting of the natural gamma and lithium and potassium ions of the brine reservoir area.

In an embodiment, in step (S3), the identification marker comprises gamma, acoustic time difference, density, porosity, and resistivity.

In an embodiment, in step (S4), the physical property parameter comprises porosity and water saturation; and the elastic parameter comprises Poisson's ratio, P-wave to S-wave velocity ratio, and Young's modulus.

In an embodiment, in step (S5), the inversion result of the natural gamma is obtained by the waveform phase-controlled inversion with the natural gamma as a sensitive parameter for seismic meme simulation.

The benefits of the present disclosure are described as follows.

The present disclosure establishes identification markers for lithium-potassium-rich brine reservoirs through rock physics modeling and logging response identification based on the water-bearing properties of lithium-potassium-rich brine reservoirs and the radioactivity of potassium-rich brine. The effective identification and precise prediction of high-quality lithium-potassium-rich brine reservoirs are achieved for the first time through the inversion of water-rich reservoirs and high-grade reservoirs (with a water content exceeding a preset value).

### BRIEF DESCRIPTION OF THE DRAWINGS

In order to clarify the technical solutions of the embodiments of the present disclosure, a brief introduction to the drawings required in the embodiments will be provided below. Obviously, presented in the accompanying drawings are only some embodiments of the present disclosure, and are not intended to limit the disclosure.

FIG. 1 is a flowchart of a method for identifying high-quality lithium-potassium-rich brine reservoirs based on parameter sensitivity analysis according to an embodiment of the present disclosure;

FIG. 2 illustrates the correlation analysis of different models with the target formation according to an embodiment of the present disclosure;

FIG. 3 is a simplified flowchart of rock physics modeling according to an embodiment of the present disclosure;

FIG. 4 shows the comparison between predicted P-wave velocity and measured P-wave velocity and the comparison between predicted density and measured density according to an embodiment of the present disclosure;

FIG. 5A shows crossplot of RD and DT of different samples in brine and other strata;

FIG. 5B shows crossplot of RD and GR of different samples in brine and other strata;

FIG. 5C shows crossplot of RD and GR of different samples in brine stratum;

FIG. 5D shows crossplot of GR and DT of different samples in brine stratum;

FIG. 6A shows the relationship between gamma ray (GR) average value and K⁺ content under different well locations;

FIG. 6B shows the relationship between the GR average value and Li⁺ content under different well locations;

FIG. 6C shows the range of the GR value at different well locations;

FIGS. 7A-B are respectively planar diagrams of predicted porosity and predicted water saturation according to an embodiment of the present disclosure; and

FIG. 8 is a planar diagram of predicted natural gamma according to an embodiment of the present disclosure.

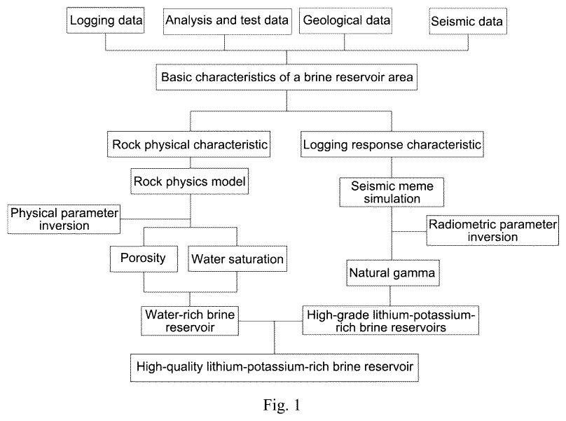

### DETAILED DESCRIPTION OF EMBODIMENTS

To make the objects, technical solutions and advantages of the embodiments of this application clearer, the technical solutions of the embodiments of this application will be clearly and completely described below in conjunction with the accompanying drawings. Based on the embodiments provided herein, all other embodiments obtained by those skilled in the art without making creative effort shall fall within the scope of this application.

The present disclosure will be described in further detail below with reference to the accompanying drawings and embodiments.

(S1) Basic characteristics of a brine reservoir area are determined based on geological data, hydrochemical analysis data, drilling and logging data, and seismic data to obtain a target geological formation.

In step (S1), the basic characteristics of the brine reservoir areas include stratigraphic features, hydrochemical characteristics, and structural features. The geological data and drilling and logging data typically provide information on regional stratigraphic characteristics and geological background, while hydrochemical analysis data from core samples and brine samples can provide physical parameters and hydrochemical characteristics of the brine reservoirs. Seismic data and geological background can provide information on the fault structures within the region.

(S2) Rock physics modeling is performed based on a rock physics model of a porous medium, so as to establish a relationship between seismic parameters and reservoir parameters. The elastic characteristics of the brine reservoir areas are analyzed to predict the density, P-wave velocity, and S-wave velocity across the entire study area, and can further be used to predict the parameters of the brine reservoir areas, such as porosity and water saturation.

In step (S2), the seismic parameters include the P-wave to S-wave velocity ratio and P-wave impedance, while the reservoir parameters include porosity and water saturation. The rock physics model is identical to the target formation in composition and structure; and the P-wave velocity in the rock physics model is identical to the P-wave velocity in the target formation under different depths. Specifically, the P-wave velocity variations observed in logging curves at different depths should be compared with the calculated results of various rock physics models, and the rock physics model that best matches the target formation should be selected. Based on the reservoir characteristics of deep brine in marine sequences, the improved Xu-White model, focusing on dolomite, is ultimately chosen as the target formation model.

(S3) Sensitive parameter analysis on a target section is performed according to the drilling and logging data and the hydrochemical analysis data to determine an identification marker of the lithium-potassium-rich brine reservoir and a distribution range of the identification marker.

In step (S3), the sensitive parameter analysis is performed on the target section by using cross-plot of logging curves. The logging curves include a natural gamma logging curve, an acoustic time difference logging curve and a resistivity logging curve. The identification markers for lithium-potassium-rich brine include low gamma, high acoustic time difference, low density, high porosity, and low resistivity.

Natural gamma represents the intensity of gamma rays emitted from the decay of radioactive elements. Potassium-rich brine, due to its high content of radioactive potassium and various minerals, typically contains the isotope 40K of potassium, resulting in higher radioactive intensity and relatively high natural gamma values. Additionally, in lithium-potassium-rich brine, there is a strong correlation between lithium and potassium, meaning that a higher concentration of the potassium ion indicates a higher grade of lithium. Therefore, in the natural gamma value range of the brine reservoir areas identified in the cross-plot analysis, small fluctuations in the gamma curve can indirectly reflect the grade of the brine reservoir.

In step (S3), the distribution range of the lithium-potassium-rich brine reservoir is determined by cross-plotting of the natural gamma and lithium and potassium ions of the brine reservoir area.

(S4) A relationship between a physical property parameter and an elastic parameter is obtained based on a rock physics model constructed in step (S2), and a coordinate range of a water-rich reservoir with a water content exceeding a preset value in the target geological formation is determined according to water-bearing characteristic of the brine reservoir area based on an inversion result of a water saturation.

In step (S4), the physical property parameters include porosity and water saturation, and the elastic parameters include Poisson's ratio, P-wave to S-wave velocity ratio, and Young's modulus.

(S5) Within the coordinate range of the water-rich reservoir, an inversion result of a natural gamma is obtained by using waveform phase-controlled inversion. Based on the inversion result of the natural gamma, a coordinate area within a distribution range of the natural gamma is extracted as a coordinate range of the lithium-potassium-rich brine reservoir.

In step (S5), the inversion result of the natural gamma is obtained by the waveform phase-controlled inversion with the natural gamma as a sensitive parameter for seismic meme simulation.

### Embodiment 1

The lithium-potassium-rich brine in the Triassic of the Sichuan Basin belongs to marine deposits. The data of step (S1) is collected to identify the occurrence lithology, stratigraphic position, reservoir characteristics, and hydrochemical properties of the deep lithium-potassium-rich brine and get the target geological formation as Leikoupo formation in Triassic strata.

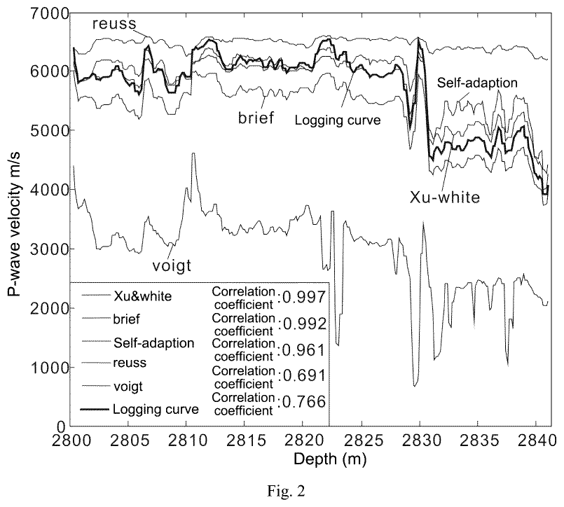

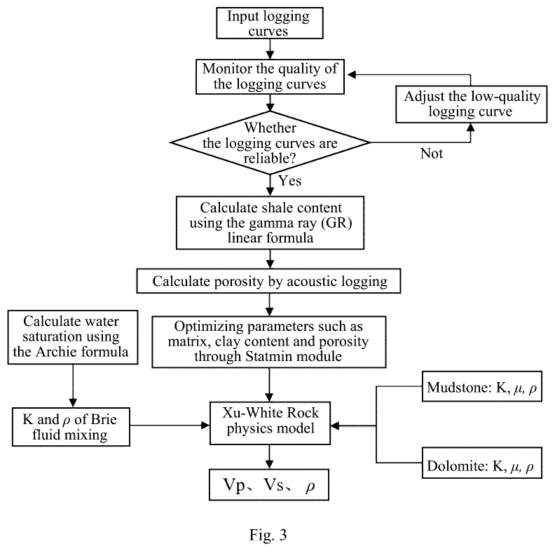

In step (S2), the target formation is located at a depth of 2,500 meters underground, and the brine is primarily found in carbonate rock reservoirs. The P-wave velocity is within a range of 5,000-7,000 m/s. The variations in P-wave velocity from the logging curves at different depths are compared with the calculated results of various models, as shown in FIG. 2. The Xu-White model has the highest correlation, with a correlation coefficient of 0.997, almost coinciding with the logging curves. Therefore, the Xu-White model is selected for the rock physics model in this study, as shown in FIG. 3.

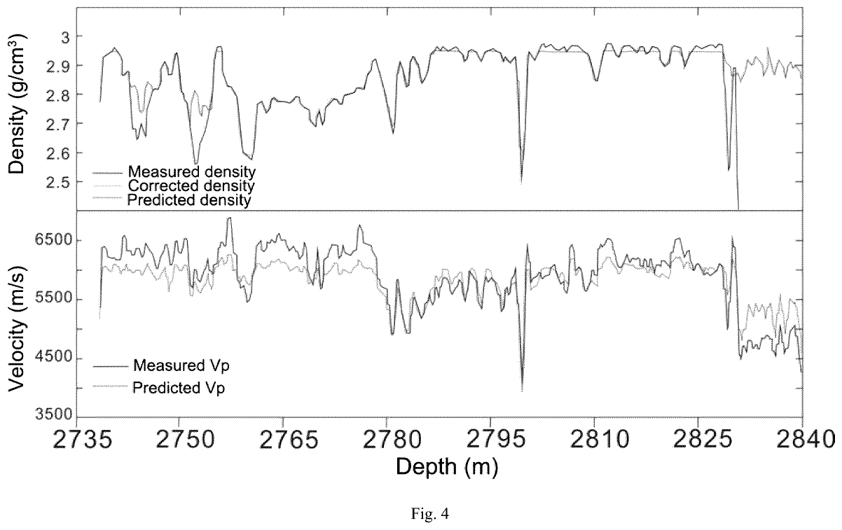

In step (S2), Well MX204 is chosen to verify the feasibility of the rock physics model. The verification results of the well logs are shown in FIG. 4. The predicted results for Well MX204 closely match the logging curves, with only minor discrepancies. The prediction results further confirm the accuracy of the constructed rock physics model, which can be used to predict density and P-wave velocity across the entire study area. Additionally, it can be used to predict reservoir parameters such as porosity and water saturation.

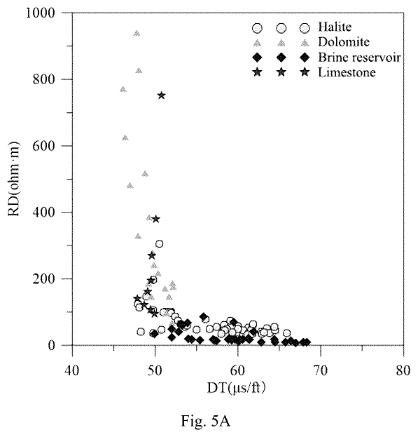

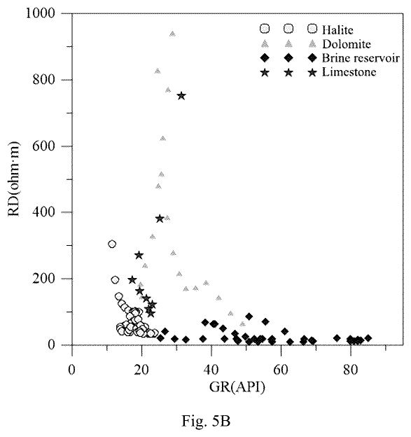

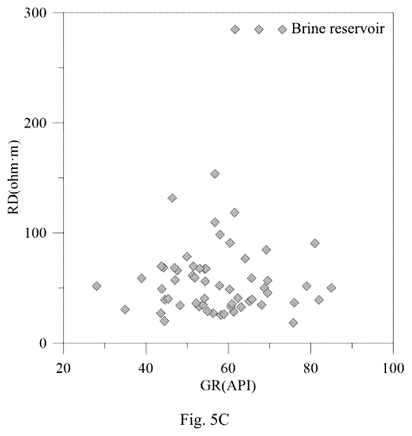

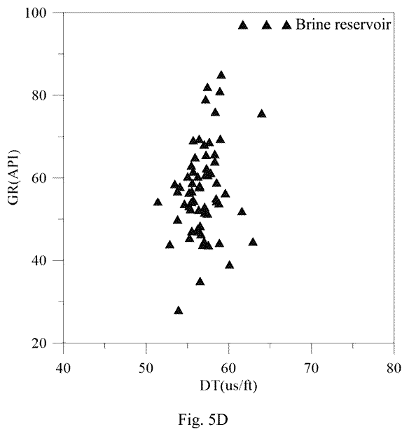

In step (S3), as shown in FIGS. 5A, 5B, 5C and 5D, cross-plots of natural gamma, resistivity, and acoustic time difference for different lithologies in the target formation are created based on the available drilling data and logging interpretations. It is found that the lithium-potassium-rich brine reservoir has clear identification markers, with distinct rock-electrical characteristics to distinguish the reservoir from the non-reservoir on the cross-plot. The Gamma Ray (GR) value range for the brine reservoir is 20-85 API, Delta-T (DT, also known as acoustic time difference) remains relatively stable within a range of 50-65 μs/ft, and RD (resistivity domain) varies slightly within a range of 0-150 ohm m (this applies only to the implementation area of this example, and specific analysis is required for different regions).

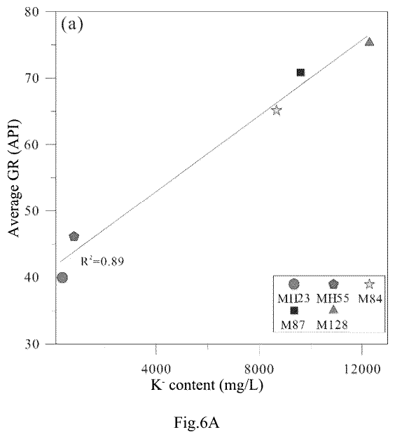

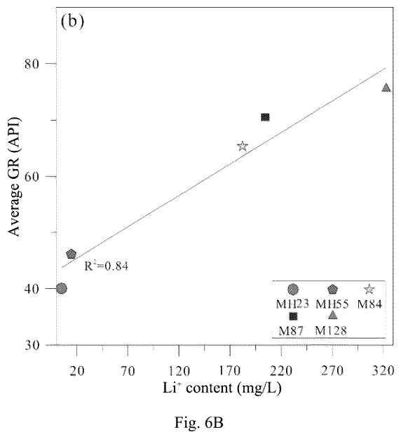

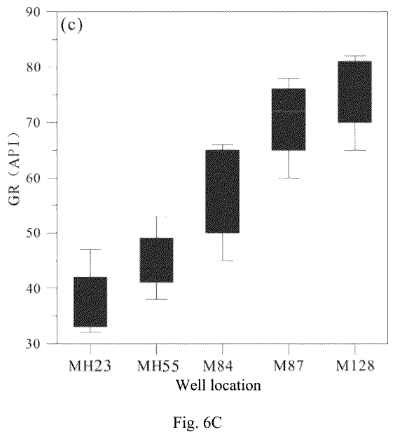

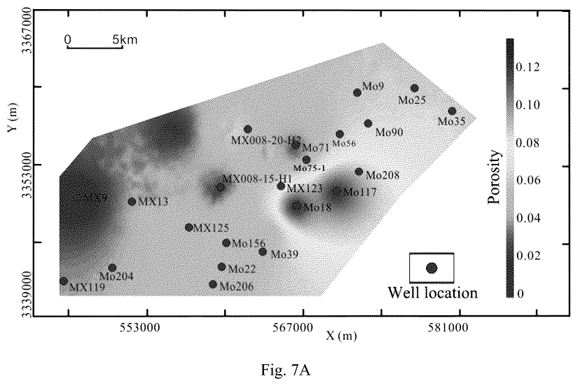

In step (S3), the potassium-rich brine, due to its high content of radioactive potassium and various minerals, typically contains the potassium isotope 40K, resulting in higher radioactivity and relatively higher natural gamma values. By averaging the GR curves of the known high-grade brine reservoirs and plotting cross-plots against potassium content and lithium content, the GR value distribution range for brine reservoirs under different ion concentrations is identified, as shown in FIGS. 6A, 6B and 6C.

TABLE 1
Hydrochemical analysis data

| | | Associated Elements (mg/L) | | | | | |
|---|---|---|---|---|---|---|---|
| Well Number | Formation | K | Li | Br × 103/Cl− | I | Br | B |
| Mo030-H | 1^{st} sub- | 277.2 | 4.8 | / | / | / | 47.68 |
| | member of | | | | | | |
| | the 1^{st} | | | | | | |
| | member of | | | | | | |
| | Leikoupo | | | | | | |
| | formation | | | | | | |
| | (L₁¹) | | | | | | |
| Mo55H | L₁¹ | 834 | 14.53 | / | / | / | 104.34 |
| Mo84 | L₁¹ | 9651 | 205 | 10.46 | 24 | 800 | 677 |
| Mo87 | L₁¹ | 8634 | 182 | 9.57 | 29 | 1251 | 1079 |
| Mo19 | L₁¹ | 12231 | 323 | 11.12 | 35 | 1341 | 852 |

The hydrochemical analysis data are shown in Table 1. The lithium and potassium ion concentrations in the Well Mo030-H are 4.8 mg/L and 277.2 mg/L, respectively; in the Well Mo55H, the lithium and potassium ion concentrations are 14.53 mg/L and 834 mg/L. Both wells are classified as low-grade brine wells, with a GR value range of 32-52 API. In contrast, the lithium ion concentrations in Wells Mo87, Mo84, and Mo19 are all above 150 mg/L, and the potassium ion concentrations are all above 8,000 mg/L, within a GR value range of 45-82 API. To accurately identify high-grade brine reservoirs, a GR value range of 50-85 API is established, using 50 API as the lower limit and the highest GR value of 85 API as the upper limit for the high-grade brine reservoirs mentioned above.

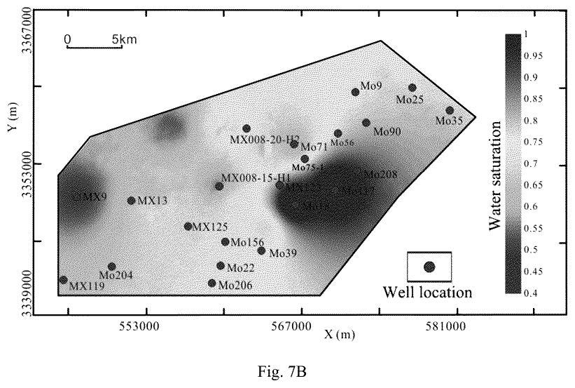

In step (S4), based on the rock physics model, the relationships between porosity, and parameters such as P-wave impedance, P-wave velocity, S-wave velocity, and density and relationships between water saturation and the above parameters can be achieved. Porosity and water saturation maps in Leikoupo formation are plotted (FIGS. 7A and 7B). The calculation formulas for porosity and water saturation in the target formation are shown in Equations 1 and 2:

$$por = 1.4939 - 0.502002 \times ρ - 9.9914 \times 1 {0}^{- 7} \times {I}_{P} + 4.24245 \times 1 {0}^{- 6} \times {V}_{P} - 9.04255 \times 1 {0}^{- 6} \times {V}_{S} ; and \qquad ( 1 )$$

$$SW = - 44.7335 \times ρ - 0.00395 \; 791 \times {I}_{P} + 0.0148494 \times {V}_{P} - 0.00681375 \times {V}_{S} . \qquad ( 2 )$$

In the equations: por represents porosity; SW represents water saturation; Vp; represents P-wave velocity; Vs represents S-wave velocity; p represents density; and Ip represents wave impedance.

The coordinates within the map where the porosity is greater than 0.06 and the water saturation is greater than 0.6 are designated as the distribution range of water-rich reservoirs in Leikoupo formation.

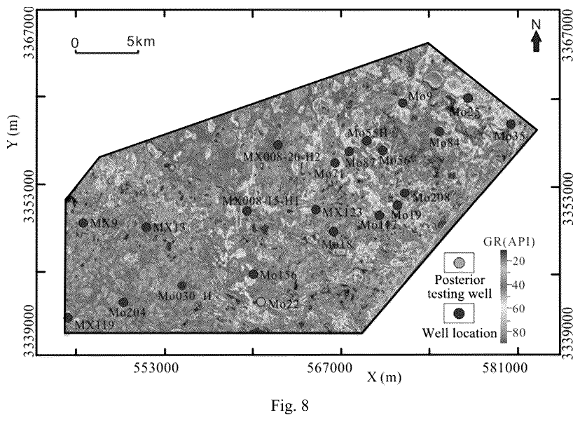

In step (S5), natural gamma is used as a sensitive parameter for waveform phase-controlled inversion to identify high-grade brine reservoirs (see FIG. 8). Within the distribution range of water-rich reservoirs determined in S4, the coordinates where the natural gamma value exceeds 50 API are output as the coordinates of high-quality brine reservoirs, defining the extent of these reservoirs. The average natural gamma value from the inversion of the brine reservoir is taken as the gamma value for that reservoir. According to the gamma inversion map, the area around wells Mo19-Mo208-Mo56 and Mo25-Mo35 has GR values ranging from 50 to 85 API, indicating the presence of high-grade brine reservoirs. Therefore, by overlaying the porosity, water saturation, and natural gamma prediction maps, it is determined that the high-quality brine reservoir is concentrated in the area near well Mo19-Mo208, with water saturation exceeding 80%, porosity over 8%, and GR values between 50 and 85 API.

It should be noted that the disclosed embodiments are merely exemplary, and are not limited to limit the present disclosure. Those skilled in the art can still make various changes, modifications and replacements to technical features recited in the above embodiments. It should be understood that those changes, modifications and replacements made without departing from the spirit of the disclosure shall fall within the scope of the disclosure defined by the appended claims.

What is claimed is:

1. A method for identifying a lithium-potassium-rich brine reservoir based on parameter sensitivity analysis, comprising:
(S1) determining basic characteristics of a brine reservoir area to obtain a target geological formation based on geological data, hydrochemical analysis data, drilling and logging data and seismic data;
(S2) performing rock physics modeling based on a rock physics model of a porous medium, so as to establish a relationship between seismic parameters and reservoir parameters;
(S3) performing sensitive parameter analysis on a target section according to the drilling and logging data and the hydrochemical analysis data to determine an identification marker of the lithium-potassium-rich brine reservoir and a distribution range of the identification maker;
(S4) obtaining a relationship between a physical property parameter and an elastic parameter based on a rock physics model constructed in step (S2); and determining a coordinate range of a water-rich reservoir with a water content exceeding a preset value in the target geological formation according to water-bearing characteristic of the brine reservoir area based on an inversion result of a water saturation; and
(S5) within the coordinate range of the water-rich reservoir, obtaining an inversion result of a natural gamma by using waveform phase-controlled inversion; and based on the inversion result of the natural gamma, extracting an area within a distribution range of the natural gamma as a coordinate range of the lithium-potassium-rich brine reservoir.

2. The method of claim 1, wherein the basic characteristics of the lithium-potassium-rich brine reservoir area comprise a stratigraphic feature, a hydrochemical characteristic and a structural feature.

3. The method of claim 1, wherein the seismic parameter comprises a primary wave (P-wave) to shear wave (S-wave) velocity ratio and a P-wave impedance; and the reservoir parameter comprises porosity and water saturation.

4. The method of claim 1, wherein in step (S2), the rock physics model is identical to a target formation in composition and structure; and a P-wave velocity in the rock physics model is identical to a P-wave velocity in the target formation under different depths.

5. The method of claim 1, wherein in step (S3), the sensitive parameter analysis is performed on the target section by using cross-plot of logging curves.

6. The method of claim 5, wherein the logging curves comprise a natural gamma logging curve, an acoustic time difference logging curve and a resistivity logging curve.

7. The method of claim 6, wherein step (S3) further comprises:
determining the distribution range of the lithium-potassium-rich brine reservoir by cross-plotting of the natural gamma and lithium and potassium ions of the brine reservoir area.

8. The method of claim 1, wherein in step (S3), the identification marker comprises gamma, acoustic time difference, density, porosity, and resistivity.

9. The method of claim 1, wherein in step (S4), the physical property parameter comprises porosity and water saturation; and the elastic parameter comprises Poisson's ratio, P-wave to S-wave velocity ratio, and Young's modulus.

10. The method of claim 1, wherein in step (S5), the inversion result of the natural gamma is obtained by the waveform phase-controlled inversion with the natural gamma as a sensitive parameter for seismic meme simulation.
